(19) United States
(12) Patent Application Publication
(10) Pub. No.: US 2016/0304320 A1
(43) Pub. Date: Oct. 20, 2016

(54) HOISTING SYSTEM WITH INCREASED AVAILABLE TRACTION

(71) Applicant: OTIS ELEVATOR COMPANY, Farmington, CT (US)

(72) Inventors: Richard J. Ericson, Southington, CT (US); Bruce P. Swaybill, Farmington, CT (US)

(21) Appl. No.: 15/101,466

(22) PCT Filed: Dec. 10, 2013
(86) PCT No.: PCT/US2013/074109

§ 371 Date: Jun. 3, 2016

(51) Int. Cl. B66B 11/08; B66B 15/04; B66B 11/04; B66B 9/00

(52) U.S. Cl. CPC B66B 11/08; B66B 9/00; B66B 15/04; B66B 11/043

(57) ABSTRACT

A hoisting system is provided that includes a first hoisted object, a second hoisted object, a tension member, a first sheave, a second sheave, a drive machine, and a traction system. The tension member connects the first and second hoisted objects. The first and second sheaves contact the tension member. The drive machine is operable to rotationally drive one of the first and second sheaves. The traction system is operable to increase a total wrap angle of the hoisting system, and thus is operable to increase an available traction of the hoisting system.

### BACKGROUND

1. Technical Field

Aspects of the present invention relate to a hoisting system, and more particularly relate to a hoisting system with increased available traction.

2. Background Information

Hoisting systems (e.g., elevator systems, crane systems) often include a first hoisted object (e.g., an elevator car), a second hoisted objected (e.g., a counterweight), a tension member (e.g., an elevator rope) that connects the first and second hoisted objects, and one or more sheaves that contact the tension member. During operation of such hoisting systems, at least one of the sheaves can be driven (e.g., by a drive machine) to move the tension member, which in turn can move the first and second hoisted objects. In order to move the tension member, it can be necessary to achieve a required traction between the tension member and the one or more sheaves. Hoisting systems typically are designed so that an available traction between the tension member and the one or more sheaves exceeds the required traction.

The available traction between the tension member and the one or more sheaves can be a function of one or more variables, including, for example, the weight of the first and second hoisted objects, speed of the first and second hoisted objects, acceleration of the first and second hoisted objects, and hoistway height. Such variables can vary depending on customer requirements. In general, lighter hoisted objects, higher speeds of the hoisted objects, higher accelerations of the hoisted objects, and shorter hoistways all contribute to a higher required traction.

The trend in hoisting system design has been toward the use of hoisted objects that weigh less than their predecessors (e.g., in order to achieve more energy-efficient hoisting systems and/or other synergistic benefits). As a result, it has become increasingly difficult to design a hoisting system that has an available traction that is greater than the required traction in all operating conditions. In order to overcome this problem, some hoisting systems employ what is known in the art as a “double wrap traction” arrangement. In a double wrap traction arrangement, at least two sheaves contact the tension member, and the tension member is wrapped about the sheaves in a manner that will be described in more detail below. The use of a double wrap traction arrangement can increase the available traction; however, in some instances, the increase in the available traction is not enough. The available traction can be increased by providing a sheave groove in one or more of the sheaves, and can be increased even further by increasing a groove undercut angle of the sheave groove. However, according to calculations provided in hoisting system codes (e.g., the EN81), providing a sheave groove can increase the amount of wear experienced by the tension member and the sheaves, and increasing a groove undercut angle of the sheave groove can even further increase that amount of wear. As indicated above, these issues can be especially problematic, for example, in hoisting systems in which the hoisted objects are moved at high speeds (e.g., at speeds equal to or greater than approximately two meters per second (2 m/s)). These issues can also be especially problematic in a hoistway system in which the hoisted objects are moved within a relatively short hoistway (e.g., a hoistway having a height between approximately twenty meters (20 m) and two hundred fifty meters (250 m)). In a hoistway system having a relatively short hoistway, the tension member is typically shorter, and thus has less mass, than a tension member that might be used in a hoisting system having a relatively tall hoistway (e.g., a hoistway having a height between four hundred meters (400 m) and one thousand meters (1000 m)). Thus, in a hoistway system having a relatively short hoistway, the tension member contributes relatively less to the available traction. Aspects of the present invention are directed these and other problems.

### SUMMARY OF ASPECTS OF THE INVENTION

According to an aspect of the present invention, a hoisting system is provided that includes a first hoisted object, a second hoisted object, a tension member, a first sheave, a second sheave, a drive machine, and a traction system. The tension member connects the first and second hoisted objects. The first and second sheaves contact the tension member. The drive machine is operable to rotationally drive one of the first and second sheaves. The traction system is operable to increase a total wrap angle of the hoisting system, and thus is operable to increase an available traction of the hoisting system.

Additionally or alternatively, the invention may incorporate one or more of the following features individually or in various combinations:
the first hoisted object is an elevator car and the second hoisted object is a counterweight;
the tension member is an elevator rope;
the first sheave is rotatable about a first sheave axis and the second sheave is rotatable about a second sheave axis, and the first and second sheaves each include a sheave contact surface, at least a portion of which is configured to contact the tension member as the respective sheave is rotated about its respective sheave axis;
the respective sheave contact surfaces each extend axially between a first sheave face surface and a second sheave face surface of the respective sheave, and the respective sheave axes each extend in a direction that is generally perpendicular to the respective planes defined by the respective first and second sheave face surfaces;
the respective sheave contact surfaces extend annularly relative to the respective sheave axes, at least one of the respective sheave contact surfaces defines an annularly-extending sheave groove that is configured to contact the tension member during operation of the hoisting system, and a shape of the sheave groove corresponds to a shape of the tension member;
the sheave groove has a groove seat portion and a groove undercut portion, the groove seat portion has an arcuate cross-sectional shape that is at least partially defined by a groove radius, and the tension member has a cross-sectional shape that is defined by a radius that is at least substantially equal to the groove radius;
the first sheave has a first diameter, the second sheave has a second diameter, and the first and second diameters are substantially different from one another;
the first sheave is rotatable about a first sheave axis and the second sheave is rotatable about a second sheave axis, and the first and second sheaves are positioned relative to one another so that their respective sheave axes extend at least substantially parallel to one another
the drive machine is operable to rotationally drive the first sheave, and the second sheave is rotationally driven only as a result of movement of the tension member;
the traction system includes a transmission device that is operable to transmit rotational drive power from the one of the first and second sheaves that is rotationally driven by the drive machine to the other of the first and second sheaves;
the transmission device includes a first sprocket connected to the first sheave, a second sprocket connected to the second sheave, and a transmission band that forms a continuous loop around the first and second sprockets and that engages the first and second sprockets to transmit rotational drive power therebetween;
the traction system includes a first sheave brake that is operable to aid in braking the first sheave and a second sheave brake that is operable to aid in braking the second sheave;
the first and second sheave brakes are configured to brake the respective sheaves simultaneously;
the first sheave is rotatable about a first sheave axis and the second sheave is rotatable about a second sheave axis, the first and second sheaves each include a sheave contact surface that extends annularly relative to the respective sheave axis, the total wrap angle represents an amount of the respective sheave contact surfaces that contact the tension member during normal operation of the hoisting system;
the tension member and the first and second sheaves are positioned relative to one another in a double wrap traction arrangement;
the total wrap angle is a sum of a first wrap angle, a second wrap angle, a third wrap angle, and a fourth wrap angle;
the first wrap angle represents an amount of the sheave contact surface of the first sheave that contacts the tension member proximate a first contact position; the second wrap angle represents an amount of the sheave contact surface of the second sheave that contacts the tension member proximate a second contact position; the third wrap angle represents an amount of the sheave contact surface of the first sheave that contacts the tension member proximate a third contact position; and the fourth wrap angle represents an amount of the sheave contact surface of the second sheave that contacts the tension member proximate a fourth contact position;
the tension member contacts the first sheave at a first contact position and at a third contact position, the tension member contacts the second sheave at a second contact position and at a fourth contact position, the tension member includes a first portion that that extends in a direction between the first hoisted object and a portion of the tension member that is in contact with the first contact position of the first sheave, the tension member includes a second portion that extends in a direction between portions of the tension member that are in contact with the first and second contact positions of the respective sheaves, the tension member includes a third portion that extends in a direction between portions of the tension member that are in contact with the second and third contact positions of the respective sheaves, the tension member includes a fourth portion that extends in a direction between portions of the tension member that are in contact with the third and fourth contact positions of the respective sheaves, and the tension member includes a fifth portion that extends in a direction between a portion of the tension member that contacts the fourth contact position of the second sheave and the second hoisted object;
the tension member and the first and second sheaves are positioned relative to one another in a single wrap traction arrangement;
the total wrap angle is a sum of a first wrap angle and a second wrap angle;
the first wrap angle represents an amount of the sheave contact surface of the first sheave that contacts the tension member proximate a first contact position and the second wrap angle represents an amount of the sheave contact surface of the second sheave that contacts the tension member proximate a second contact position; and
the tension member contacts the first sheave at a first contact position, the tension member contacts the second sheave at a second contact position, the tension member includes a first portion that that extends in a direction between the first hoisted object and a portion of the tension member that is in contact with the first contact position of the first sheave, the tension member includes a second portion that extends in a direction between portions of the tension member that are in contact with the first and second contact positions of the respective sheaves, and the tension member includes a third portion that extends in a direction between a portion of the tension member that contacts the third contact position of the second sheave and the second hoisted object.

These and other aspects of the present invention will become apparent in light of the drawings and detailed description provided below.

### BRIEF DESCRIPTION OF THE DRAWING

FIG. 1 is a schematic illustration of a hoisting system.

FIG. 2 is a schematic illustration of another hoisting system.

FIG. 3 is a schematic illustration of another hoisting system.

FIG. 4 is a sectional view of a tension member contacting the first sheave of the hoisting system of FIG. 1.

### DETAILED DESCRIPTION OF ASPECTS OF THE INVENTION

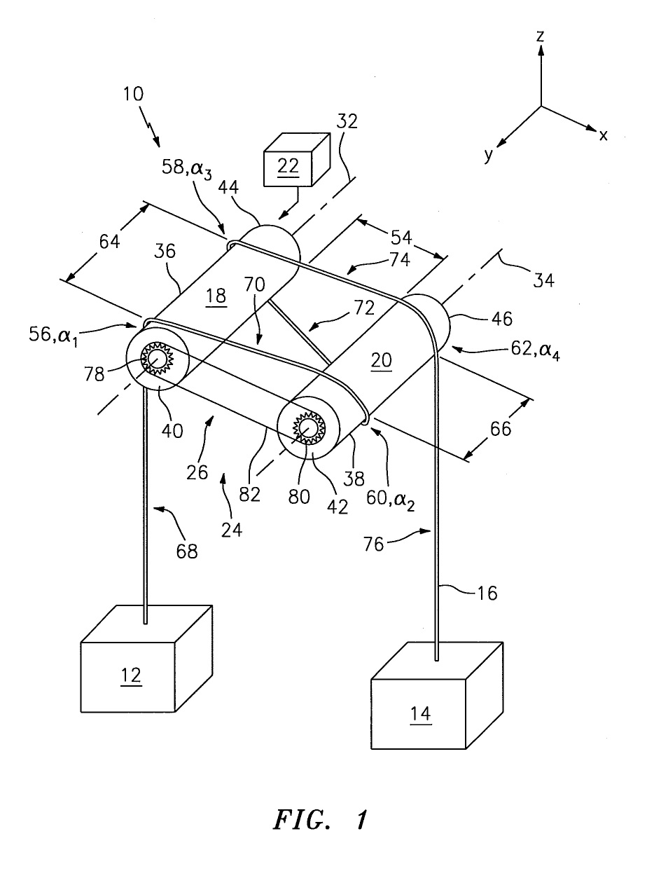

Referring to FIGS. 1-3, the present disclosure describes embodiments of a hoisting system 10. The present disclosure describes aspects of the present invention with reference to the embodiments illustrated in the drawings; however, aspects of the present invention are not limited to the embodiments illustrated in the drawings. The present disclosure may describe one or more features as having a length extending relative to a x-axis, a width extending relative to a y-axis, and/or a height extending relative to a z-axis. The drawings illustrate the respective axes.

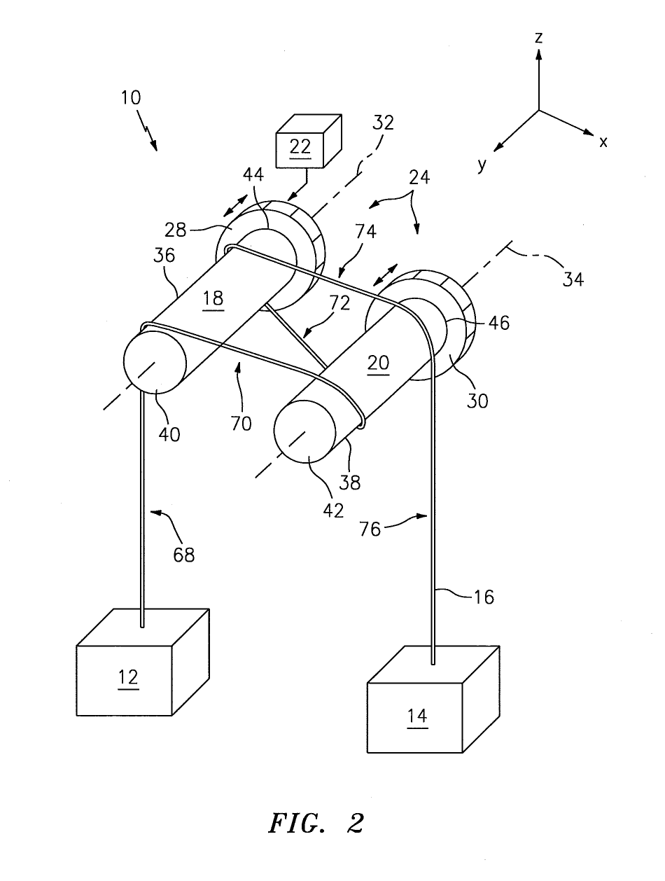

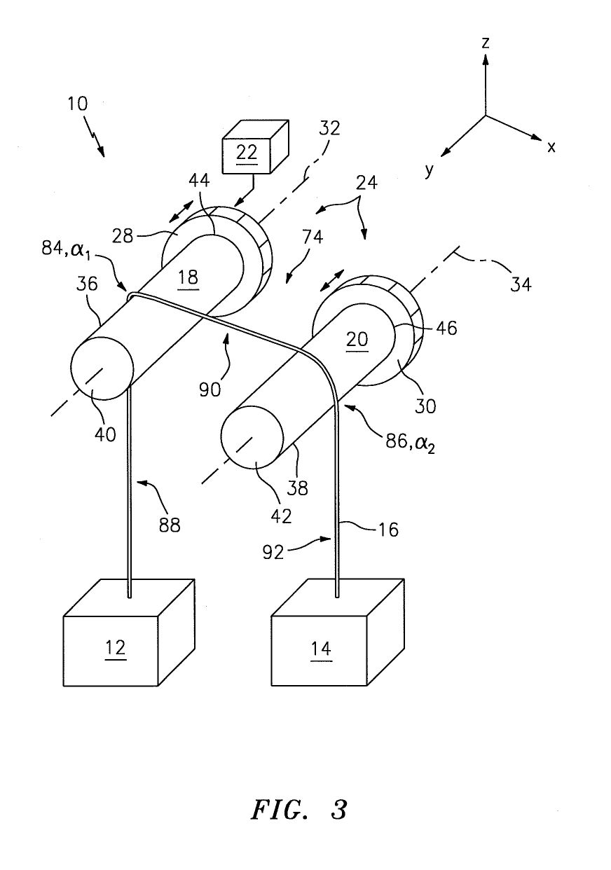

The hoisting system 10 includes a first hoisted object 12, a second hoisted object 14, a tension member 16, a first sheave 18, a second sheave 20, a drive machine 22, and a traction system 24. The tension member 16 connects the first and second hoisted objects 12, 14. The first and second sheaves 18, 20 contact the tension member 16. The drive machine 22 is operable to rotationally drive one of the first and second sheaves 18, 20, which in turn can move the tension member 16 and the first and second hoisted objects 12, 14. The traction system 24 is operable to increase a total wrap angle α of the hoisting system 10, and thus is operable to increase an available traction TR_{available} of the hoisting system 10. The total wrap angle α and the available traction TR_{available} will be described in detail below. The traction system 24 includes one or both of a transmission device 26 (see FIG. 1) and a pair of sheave brakes 28, 30 (see FIGS. 2 and 3).

The first and second hoisted objects 12, 14 can each have various different structures. In the embodiments illustrated in FIGS. 1-3, the first hoisted object 12 is an elevator car, and the second hoisted object 14 is a counterweight.

The tension member 16 can have various different structures. In the embodiments illustrated in FIGS. 1-3, the tension member 16 is an elevator rope that includes a plurality of steel wires that are stranded together in a known manner.

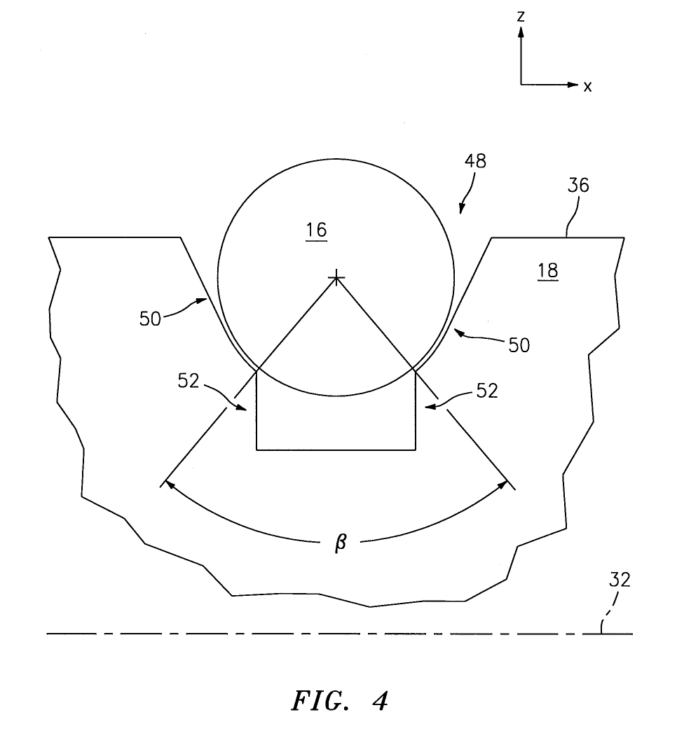

The first and second sheaves 18, 20 each are rotatable about a respective sheave axis 32, 34. The first and second sheaves 18, 20 each include a respective sheave contact surface 36, 38, at least a portion of which is configured to contact the tension member 16 as the respective sheave 18, 20 is rotated about its respective sheave axis 32, 34 during operation of the hoisting system 10. The first and second sheaves 18, 20 can have various different configurations. In the embodiments illustrated in FIGS. 1-3, the respective sheave contact surfaces 36, 38 each extend axially between a respective first sheave face surface 40, 42 and a respective second sheave face surface 44, 46 of the respective sheave 18, 20. The respective sheave axes 32, 34 extend in a widthwise direction that is generally perpendicular to the respective planes defined by the respective first and second sheave face surfaces 40, 42, 44, 46. The respective sheave contact surfaces 36, 38 extend annularly relative to the respective sheave axes 32, 34. The sheave contact surfaces 36, 38 are concentric relative to the respective sheave axes 32, 34. The sheave contact surfaces 36, 38 each define a one or more of annularly-extending sheave grooves 48 (see FIG. 4) that are configured to contact the tension member 16 during operation of the hoisting system 10.

In embodiments such as the one illustrated in FIGS. 1-3, in which the sheave contact surfaces 36, 38 each form one or more sheave grooves 48, a shape of the sheave grooves 48 can correspond to a shape of the tension member 16. Referring to FIG. 4, for example, in this embodiment the sheave groove 48 has a groove seat portion 50 and a groove undercut portion 52. The groove seat portion 50 has an arcuate cross-sectional shape that is partially defined by a groove radius. The tension member 16 has a cross-sectional shape that is defined by a radius that is at least substantially equal to the groove radius. The sheave groove 48 can further be described as having a groove undercut angle β, the significance of which will be described in more detail below.

The respective sizes of the first and second sheaves 18, 20 can vary. In some embodiments, for example, the respective diameters of the first and second sheaves 18, 20 can be as small as approximately fifteen centimeters (15 cm), while in other embodiments the respective diameters of the first and second sheaves 18, 20 can be as large as approximately one and one half meters (1.5 m). In some embodiments, the first sheave 18 has a first diameter, the second sheave 20 has a second diameter, and the first and second diameters are substantially different from one another. In some embodiments, for example, the first diameter of the first sheave 18 can be approximately ten percent (10%) greater in size than the second diameter of the second sheave 20.

The relative positioning of the first and second sheaves 18, 20 can vary. In some embodiments, including the embodiments illustrated in the drawings, the first and second sheaves 18, 20 are positioned relative to one another so that their respective axes 32, 34 extend at least substantially parallel to one another. The first and second sheaves 18, 20 can be positioned relative to one another so that their respective axes 32, 34 are at the same heightwise position, or so that a distance extends in a heightwise direction between the respective axes 32, 34.

The relative positioning of the tension member 16 and the first and second sheaves 18, 20 can vary. The tension member 16 and the first and second sheaves 18, 20 can be positioned relative to one another in a so-called “double wrap traction” arrangement (see FIGS. 1 and 2), a so-called “single wrap traction” arrangement (see FIG. 3), or another arrangement.

In the double wrap traction arrangement shown in FIGS. 1 and 2, the tension member 16 contacts the first sheave 18 at a first contact position 56 and at a third contact position 58, and the tension member 16 contacts the second sheave 20 at a second contact position 60 and at a fourth contact position 62. The first and third contact positions 56, 58 are separated by a widthwise-extending distance 64 (see FIG. 1), and the second and fourth contact positions 60, 62 are separated by a widthwise-extending distance 66 (see FIG. 1). The tension member 16 has a first portion 68 that extends in a generally heightwise direction between the first hoisted object 12 and the portion of the tension member 16 that is in contact with the first contact position 56 of the first sheave 18; a second portion 70 that extends in a generally lengthwise direction between the portions of the tension member 16 that are in contact with the first and second contact positions 56, 58 of the respective sheaves 18, 20; a third portion 72 that extends in a generally lengthwise direction between the portions of the tension member 16 that are in contact with the second and third contact positions 60, 58 of the respective sheaves 18, 20; a fourth portion 74 that extends in a generally lengthwise direction between the portions of the tension member 16 that are in contact with the third and fourth contact positions 58, 62 of the respective sheaves 18, 20; and a fifth portion 76 that extends in a generally heightwise direction between the portion of the tension member 16 that contacts the fourth contact position 62 of the second sheave 20 and the second hoisted object 14. Each of the above-described portions of the tension member 16 will vary in length as the first and second hoisted objects 12, 14 are moved during operation of the hoisting system 10.

In the single wrap traction arrangement shown in FIG. 3, the tension member 16 contacts the first sheave 18 at a first contact position 84 and at a second contact position 86. The tension member 16 has a first portion 88 that extends in a generally heightwise direction between the first hoisted object 12 and the portion of the tension member 16 that is in contact with the first contact position 84 of the first sheave 18; a second portion 90 that extends in a generally lengthwise direction between the portions of the tension member 16 that are in contact with the first and second contact positions 84, 86 of the respective sheaves 18, 20; and a third portion 92 that extends in a generally heightwise direction between the portion of the tension member 16 that contacts the second contact position 86 of the second sheave 20 and the second hoisted object 14. Each of the above-described portions of the tension member 16 will vary in length as the first and second hoisted objects 12, 14 are moved during operation of the hoisting system 10.

The relative positioning of the tension member 16 and the first and second sheaves 18, 20 can be characterized by one or more wrap angles. Each wrap angle represents, in radians, an amount of the respective sheave contact surfaces 36, 38 of the first and second sheaves 18, 20 that contacts the tension member 16 during normal operation of the hoisting system 10.

In the double wrap traction arrangement shown in FIGS. 1 and 2, the hoisting system 10 includes a first wrap angle α₁ (see FIG. 1) representative of an amount of the sheave contact surface 36 of the first sheave 18 that contacts the tension member 16 at the first contact position 56; a second wrap angle α₂ (see FIG. 1) representative of an amount of the sheave contact surface 38 of the second sheave 20 that contacts the tension member 16 at the second contact position 60; a third wrap angle α₃ (see FIG. 1) representative of an amount of the sheave contact surface 36 of the first sheave 18 that contacts the tension member 16 at the third contact position 58; and a fourth wrap angle α₄ (see FIG. 1) representative of an amount of the sheave contact surface 38 of the second sheave 20 that contacts the tension member 16 at the fourth contact position 62. In these embodiments, the first wrap angle α₁ is approximately one hundred fifty degrees (150°); the second wrap angle α₂ is approximately one hundred eighty degrees) (180°; the third wrap angle α₃ is approximately one hundred eighty degrees (180°); and the fourth wrap angle α₄ is approximately thirty degrees (30°).

In the single wrap traction arrangement shown in FIG. 3, the hoisting system 10 includes a first wrap angle α₁ representative of an amount of the sheave contact surface 36 of the first sheave 18 that contacts the tension member 16 at the first contact position 84; and a second wrap angle α₂ representative of an amount of the sheave contact surface 38 of the second sheave 20 that contacts the tension member 16 at the second contact position 86. In this embodiment, the first wrap angle α₁ is approximately one hundred fifty degrees (150°), and the second wrap angle α₂ is approximately thirty degrees (30°).

The drive machine 22 can have various different configurations and can function in various different ways. As indicated above, the drive machine 22 is operable to rotationally drive one of the first and second sheaves 18, 20. In the embodiment illustrated in FIG. 1, for example, the drive machine 22 is operable to rotationally drive the first sheave 18, and the second sheave 20 is rotationally driven by the transmission device 26, as will be described in detail below. In the embodiments illustrated in FIGS. 2 and 3, the drive machine 22 is operable to rotationally drive the first sheave 18, and the second sheave 20 is rotationally driven as a result of movement of the tension member 16. The power output of the drive machine 22 can vary depending on one or more variables, including, for example, the respective weights of the first and second hoisted objects 12, 14.

In embodiments that include a transmission device 26 (see FIG. 1), the transmission device 26 is operable to transmit rotational drive power from the one of the first and second sheaves 18, 20 that is rotationally driven by the drive machine 22 to the other of the first and second sheaves 18, 20. In the embodiment illustrated in FIG. 1, the drive machine 22 is operable to rotationally drive the first sheave 18, and the transmission device 26 is operable to transmit rotational drive power from the first sheave 18 to the second sheave 20. The transmission device 26 can have various different configurations and can function in various different ways. In the embodiment illustrated in FIG. 1, the transmission device 26 includes a first sprocket 78 connected to the first sheave face surface 40 of the first sheave 18, a second sprocket 80 connected to the first sheave face surface 42 of the second sheave 20, and a transmission band 82 that forms a continuous loop around the first and second sprockets 78, 80. In this embodiment, an inner side of the transmission band 82 includes structure (not shown) that the first and second sprockets 78, 80 engage to transmit rotational drive power therebetween. In other embodiments not shown in the drawings, the transmission device 26 can be implemented using one or more gears, and/or one or more other structures that are operable to transmit power from one object to another.

In embodiments in which the traction system 24 includes a pair of sheave brakes 28, 30 (see FIGS. 2 and 3), the pair of sheave brakes 28, 30 includes a first sheave brake 28 that is operable to aid in braking (i.e., slowing or stopping rotation of) the first sheave 18, and a second sheave brake 30 that is operable to aid in braking the second sheave 20. The first and second sheave brakes 28, 30 can have various different configurations and can function in various different ways. In some embodiments, for example, the first and second sheave brakes 28, 30 can each be in the form of a drum brake. In other embodiments, including the embodiments illustrated in FIGS. 2 and 3, the first and second sheave brakes 28, 30 can each be in the form of a disc brake. In the embodiments illustrated in FIGS. 2 and 3, the first sheave brake 28 is operable to aid in braking the first sheave 18 by frictionally engaging the second sheave face surface 44 of the first sheave 18, and the second sheave brake 30 is operable to aid in braking the second sheave 20 by frictionally engaging the second sheave face surface 46 of the second sheave 20. In some embodiments, the first and second sheave brakes 28, 30 can be configured to brake the respective sheaves 18, 20 simultaneously; the first and second sheave brakes 28, 30 can be configured to operate independently of one another; and/or the first and second sheave brakes 28, 30 can be configured to operate together. In some embodiments that include first and second sheave brakes 28, 30, the hoisting system 10 additionally includes a brake controller (not shown) that is operable to control the first and second sheave brakes 28, 30. In such embodiments, the functionality of the brake controller can be implemented using hardware, software, firmware, or a combination thereof. In some embodiments, for example, the brake controller includes one or more programmable processors. A person having ordinary skill in the art would be able to adapt (e.g., program) the controller to perform the functionality described herein without undue experimentation.

In the running condition of the hoisting system 10, the drive machine 22 rotationally drives one or both of the first and second sheaves 18, 20, which in turn moves the tension member 16. In the running condition, the available traction TR_{available} should be greater than or equal to the required traction TR_{required} of the hoisting system 10. The required traction TR_{required} can be determined using the following equation:

$${TR}_{required} = max of \{ \frac{{T}_{1}}{{T}_{2}} or \frac{{T}_{2}}{{T}_{1}} \} \qquad ( Equation 1 )$$

In Equation 1, T₁ is a variable that represents the tension of a portion of the tension member 16 extending from the first hoisted object 12 (e.g., the first portion 68 of the tension member 16 in FIG. 1, or the first portion 88 of the tension member 16 in FIG. 3), and T₂ is a variable that represents the tension of a portion of the tension member 16 extending from the second hoisted object 14 (e.g., the fifth portion 76 of the tension member 16 in FIG. 1, or the third portion 92 of the tension member 16 in FIG. 3). In this embodiment, the available traction TR_{available} can be determined using the following equation:

TR_{available}=e^{f·α} (Equation 2)

In Equation 2, e is the mathematical constant that is the base of the natural logarithm, f is a friction factor between the tension member 16 and the first and second sheaves 18, 20, and a represents the total wrap angle of the hoisting system 10. The total wrap angle α is a sum of one or more wrap angles of the hoisting system 10, as will be described in more detail below. In Equation 2, the friction factor f can be determined using various different equations. The particular equation used to determine the friction factor f will depend at least in part on a shape of the respective sheave contact surfaces 36, 38 of the first and second sheaves 18, 20. In the embodiment illustrated in FIG. 1, the respective sheave contact surfaces 36, 38 of the first and second sheaves 18, 20 each include a plurality of sheave grooves 48, which each have the cross-sectional shape shown in FIG. 4. In this embodiment, the friction factor f can be determined using the following equation:

$$f = \frac{4 \cdot μ \cdot ( 1 - sin \frac{β}{2} )}{π - β - sin ( β )} \qquad ( Equation 3 )$$

In Equation 3, μ is a coefficient of friction, β is the groove undercut angle β described above, and π is the mathematical constant that is the ratio of a circle's circumference to its diameter.

As discussed above, the traction system 24 is operable to increase a total wrap angle α of the hoisting system 10, and thus is operable to increase an available traction TR_{available} of the hoisting system 10.

In embodiments in which the traction system 24 includes a transmission device 26 (see FIG. 1), the transmission device 26 transmits rotational drive power from the first sheave 18 to the second sheave 20, which has the effect of increasing the number of wrap angles that contribute to the total wrap angle α. In the embodiment illustrated in FIG. 1, the total wrap angle α is equal to the sum of the first wrap angle α₁, the second wrap angle α₂, the third wrap angle α₃, and the fourth wrap angle α₄. In this embodiment, therefore, the total wrap angle α is approximately five hundred forty degrees (540°). If the transmission device 26 were excluded from this embodiment, the second and fourth wrap angles α₂, α₄ would not contribute to the total wrap angle α, and thus the total wrap angle α would be approximately three hundred thirty degrees (330°).

In embodiments that include first and second sheave brakes 28, 30 (see FIGS. 2 and 3), the first and second sheave brakes 28, 30 simultaneously brake the respective first and second sheaves 18, 20, which has the effect of increasing the number of wrap angles that contribute to the total wrap angle α. In the embodiment illustrated in FIG. 2, the total wrap angle α is equal to the sum of the first wrap angle α₁, the second wrap angle α₂, the third wrap angle α₃, and the fourth wrap angle α₄. In this embodiment, therefore, the total wrap angle α is approximately five hundred forty degrees (540°). If the transmission device 26 were excluded from this embodiment, the second and fourth wrap angles α₂, α₄ would not contribute to the total wrap angle α, and thus the total wrap angle α would be approximately three hundred thirty degrees (330°). In the embodiment illustrated in FIG. 3, the total wrap angle α is equal to the sum of the first wrap angle α₁ and the second wrap angle α₂. In this embodiment, therefore, the total wrap angle α is approximately one hundred eighty (180°). If the transmission device 26 were excluded from this embodiment, the second wrap angle α₂ would not contribute to the total wrap angle α, and thus the total wrap angle α would be approximately one hundred thirty (130°).

While several embodiments have been disclosed, it will be apparent to those of ordinary skill in the art that aspects of the present invention include many more embodiments and implementations. Accordingly, aspects of the present invention are not to be restricted except in light of the attached claims and their equivalents. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

What is claimed is:

1. A hoisting system, comprising:
a first hoisted object and a second hoisted object;
a tension member that connects the first and second hoisted objects;
a first sheave contacting the tension member and a second sheave contacting the tension member;
a drive machine that is operable to rotationally drive one of the first and second sheaves; and
a traction system that is operable to increase a total wrap angle α of the hoisting system, and thus is operable to increase an available traction of the hoisting system.

2. The hoisting system of claim 1, wherein the first hoisted object is an elevator car and the second hoisted object is a counterweight.

3. The hoisting system of claim 1, wherein the tension member is an elevator rope.

4. The hoisting system of claim 1, wherein the first sheave is rotatable about a first sheave axis and the second sheave is rotatable about a second sheave axis; and
wherein the first and second sheaves each include a sheave contact surface, at least a portion of which is configured to contact the tension member as the respective sheave is rotated about its respective sheave axis.

5. The hoisting system of claim 4, wherein the respective sheave contact surfaces each extend axially between a first sheave face surface and a second sheave face surface of the respective sheave; and
wherein the respective sheave axes each extend in a direction that is generally perpendicular to the respective planes defined by the respective first and second sheave face surfaces.

6. The hoisting system of claim 4, wherein the respective sheave contact surfaces extend annularly relative to the respective sheave axes;
wherein at least one of the respective sheave contact surfaces defines an annularly-extending sheave groove that is configured to contact the tension member during operation of the hoisting system; and
wherein a shape of the sheave groove corresponds to a shape of the tension member.

7. The hoisting system of claim 6, wherein the sheave groove has a groove seat portion and a groove undercut portion;
wherein the groove seat portion has an arcuate cross-sectional shape that is at least partially defined by a groove radius;
and wherein the tension member has a cross-sectional shape that is defined by a radius that is at least substantially equal to the groove radius.

8. The hoisting system of claim 1, wherein the first sheave has a first diameter, the second sheave has a second diameter, and the first and second diameters are substantially different from one another.

9. The hoisting system of claim 1, wherein the first sheave is rotatable about a first sheave axis and the second sheave is rotatable about a second sheave axis; and
wherein the first and second sheaves are positioned relative to one another so that their respective sheave axes extend at least substantially parallel to one another.

10. The hoisting system of claim 1, wherein the drive machine is operable to rotationally drive the first sheave; and
wherein the second sheave is rotationally driven only as a result of movement of the tension member.

11. The hoisting system of claim 1, wherein the traction system includes a transmission device that is operable to transmit rotational drive power from the one of the first and second sheaves that is rotationally driven by the drive machine to the other of the first and second sheaves.

12. The hoisting system of claim 11, wherein the transmission device includes a first sprocket connected to the first sheave, a second sprocket connected to the second sheave, and a transmission band that forms a continuous loop around the first and second sprockets and that engages the first and second sprockets to transmit rotational drive power therebetween.

13. The hoisting system of claim 1, wherein the traction system includes a first sheave brake that is operable to aid in braking the first sheave and a second sheave brake that is operable to aid in braking the second sheave.

14. The hoisting system of claim 13, wherein the first and second sheave brakes are configured to brake the respective sheaves simultaneously.

15. The hoisting system of claim 1, wherein the first sheave is rotatable about a first sheave axis and the second sheave is rotatable about a second sheave axis;
wherein the first and second sheaves each include a sheave contact surface that extends annularly relative to the respective sheave axis;
wherein the total wrap angle represents an amount of the respective sheave contact surfaces that contact the tension member during normal operation of the hoisting system.

16. The hoisting system of claim 1, wherein the tension member, the first sheave, and the second sheave are positioned relative to one another in a double wrap traction arrangement

17. The hoisting system of claim 16, wherein the total wrap angle is a sum of a first wrap angle, a second wrap angle, a third wrap angle, and a fourth wrap angle.

18. The hoisting system of claim 17, wherein the first wrap angle represents an amount of the sheave contact surface of the first sheave that contacts the tension member proximate a first contact position; the second wrap angle represents an amount of the sheave contact surface of the second sheave that contacts the tension member proximate a second contact position; the third wrap angle represents an amount of the sheave contact surface of the first sheave that contacts the tension member proximate a third contact position; and the fourth wrap angle represents an amount of the sheave contact surface of the second sheave that contacts the tension member proximate a fourth contact position.

19. The hoisting system of claim 16, wherein the tension member contacts the first sheave at a first contact position and at a third contact position;
wherein the tension member contacts the second sheave at a second contact position and at a fourth contact position;
wherein the tension member includes a first portion that that extends in a direction between the first hoisted object and a portion of the tension member that is in contact with the first contact position of the first sheave;
wherein the tension member includes a second portion that extends in a direction between portions of the tension member that are in contact with the first and second contact positions of the respective sheaves
wherein the tension member includes a third portion that extends in a direction between portions of the tension member that are in contact with the second and third contact positions of the respective sheaves;
wherein the tension member includes a fourth portion that extends in a direction between portions of the tension member that are in contact with the third and fourth contact positions of the respective sheaves; and
wherein the tension member includes a fifth portion that extends in a direction between a portion of the tension member that contacts the fourth contact position of the second sheave and the second hoisted object.

20. The hoisting system of claim 1, wherein the tension member and the first and second sheaves are positioned relative to one another in a single wrap traction arrangement.

21. The hoisting system of claim 20, wherein the total wrap angle is a sum of a first wrap angle and a second wrap angle.

22. The hoisting system of claim 21, wherein the first wrap angle represents an amount of the sheave contact surface of the first sheave that contacts the tension member proximate a first contact position and the second wrap angle represents an amount of the sheave contact surface of the second sheave that contacts the tension member proximate a second contact position.

23. The hoisting system of claim 20, wherein the tension member contacts the first sheave at a first contact position;
wherein the tension member contacts the second sheave at a second contact position;
wherein the tension member includes a first portion that that extends in a direction between the first hoisted object and a portion of the tension member that is in contact with the first contact position of the first sheave;
wherein the tension member includes a second portion that extends in a direction between portions of the tension member that are in contact with the first and second contact positions of the respective sheaves; and
wherein the tension member includes a third portion that extends in a direction between a portion of the tension member that contacts the third contact position of the second sheave and the second hoisted object.
